(19) United States
(12) Patent Application Publication
(10) Pub. No.: US 2026/0022974 A1
(43) Pub. Date: Jan. 22, 2026

(54) Wireless Temperature Sensor and Communication Method Therefor

(71) Applicant: Aktiebolaget SKF, Goteborg (SE)

(72) Inventors: Xing Yi, Shanghai (CN); Chenguang WANG, Shanghai (CN); Yeda WAN, Shanghai (CN); Sheng FAN, Shanghai (CN); Wen LU, Shangai (CN)

(21) Appl. No.: 19/265,405

(22) Filed: Jul. 10, 2025

(30) Foreign Application Priority Data
Jul. 17, 2024 (CN) 202410957117.2

(51) Int. Cl. G01K 1/024

(52) U.S. Cl. CPC G01K 1/024

(57) ABSTRACT

The present disclosure pertains to a wireless temperature sensor and a communication method thereof. The communication method may include collecting temperature data at a first operating frequency and determining whether the temperature data is within a predetermined threshold range. When the temperature data is within the predetermined threshold range, the method may include transmitting the temperature data to a temperature data receiving device at a second operating frequency by broadcasting without establishing communication connection with the temperature data receiving device. The first operating frequency can be greater than the second operating frequency.

### CROSS-REFERENCE TO RELATED APPLICATION

This application is based on and claims priority to Chinese Patent Application No. 202410957117.2, filed on Jul. 17, 2024 in the Chinese Patent Office, the entirety of which is hereby incorporated by reference.

### FIELD

The disclosure relates to electronic devices, and in particular, to wireless temperature sensors and communication methods therefor.

### BACKGROUND

A temperature sensor is a sensor that can sense the temperature and convert it into a usable output signal. The existing temperature sensors are generally wired, that is, the existing temperature sensors transmit the obtained temperature data to the data receiving device by wired means (for example, through data lines). This wired mode is not conducive to the installation and maintenance of the temperature sensor, which limits the use scenarios of the temperature sensor.

In addition, in order to facilitate installation and use, a temperature sensor with small volume and long service life is desired. However, the volume of the temperature sensor is mainly affected by the volume of the power supply inside the temperature sensor. When a large-capacity and large-volume power supply is used in the temperature sensor to support the long-term use of the temperature sensor, the volume of the temperature sensor is large. When a small-capacity and small-volume power supply is used in the temperature sensor to facilitate the installation of the temperature sensor, the service time of the temperature sensor is short.

Therefore, a wireless temperature sensor with small volume and low power consumption is expected.

### SUMMARY

According to at least one embodiment of the present disclosure, there is provided a communication method for a wireless temperature sensor, including: collecting temperature data at a first operating frequency; determining whether the temperature data is within a predetermined threshold range; and when the temperature data is within the predetermined threshold range, transmitting the temperature data to a temperature data receiving device at a second operating frequency by broadcasting without establishing communication connection with the temperature data receiving device, wherein the first operating frequency is greater than the second operating frequency.

For example, the method according to an embodiment of the present disclosure, wherein transmitting the temperature data to the temperature data receiving device by broadcasting comprises repeatedly transmitting the temperature data in a plurality of broadcast frames.

For example, a method according to an embodiment of the present disclosure, wherein each broadcast frame in the plurality of broadcast frames is transmitted through one or more channels.

For example, the method according to an embodiment of the present disclosure, wherein a time interval between adjacent broadcast frames in the plurality of broadcast frames is a predetermined time interval.

For example, the method according to the embodiment of the present disclosure, wherein a time interval between adjacent broadcast frames in the plurality of broadcast frames is a random time interval.

For example, the method according to the embodiment of the present disclosure, wherein the transmitting by broadcasting is performed by one or more of Bluetooth low power BLE, Bluetooth BL, sub-Ghz, wireless HART, infrared link, ZigBee, radio frequency identification RFID, WIFI and near field communication NFC.

For example, the method according to the embodiment of the present disclosure, wherein the wireless temperature sensor includes a control module, a power supply module and a temperature measuring module, wherein the control module obtains power from the power supply module and performs a power management function and a power conversion function, wherein, the control module transmits power to the temperature measuring module through a control interface.

For example, a method according to an embodiment of the present disclosure, wherein the control interface comprises a general-purpose input-output GIPO port.

For example, the method according to the embodiment of the present disclosure further includes: when the temperature data is not within the predetermined threshold range, immediately transmitting the temperature data to the temperature data receiving device by broadcasting.

For example, the method according to the embodiment of the present disclosure further includes determining the number of times of anomalies that the temperature data is not within the predetermined threshold range within a predetermined time period; comparing the number of times of anomalies with the threshold number of times; and determining whether to update the second operating frequency based on a comparison result, wherein, the threshold number of times includes an upper threshold number of times and a lower threshold number of times.

For example, the method according to the embodiment of the present disclosure, wherein determining whether to update the second operating frequency based on the comparison result includes: determining to update the second operating frequency based on the comparison result indicating that the number of times of anomalies is higher than the upper threshold number of times or lower than the lower threshold number of times.

For example, the method according to the embodiment of the present disclosure, wherein updating the second operating frequency includes: increasing the second operating frequency based on the comparison result indicating that the number of times of anomalies is higher than the upper threshold number of times; and reducing the second operating frequency based on the comparison result indicating that the number of times of anomalies is lower than the lower threshold number of times.

For example, the method according to the embodiment of the present disclosure, wherein determining whether to update the second operating frequency based on the comparison result includes: determining not to update the second operating frequency based on the comparison result indicating that the number of times of anomalies is between the upper threshold number of times and the lower threshold number of times.

According to at least one embodiment of the present disclosure, there is provided a wireless temperature sensor comprising: a temperature measuring module configured to collect temperature data; a communication module including an antenna component configured to broadcast temperature data to a temperature data receiving device; a control module configured to: control the temperature measuring module to collect temperature data at a first operating frequency, determine whether the temperature data is within a predetermined threshold range, and when the temperature data is within the predetermined threshold range, control the communication module to transmit the temperature data to the temperature data receiving device at a second operating frequency by broadcasting without establishing communication connection with the temperature data receiving device, wherein the first operating frequency is greater than the second operating frequency.

The wireless temperature sensor and the communication method therefor according to the embodiment of the present disclosure can broadcast temperature data to a temperature data receiving device without establishing a communication connection. Because the process of establishing communication connection is reduced, the power consumption of wireless temperature sensor for communication can be significantly reduced. In addition, the controller of the wireless temperature sensor according to the embodiment of the present disclosure can realize the power management function, and can transmit power from the controller to the temperature measurement module via the control interface without a large number of power conversion circuits. By omitting a large number of power conversion circuits, the power consumption of the wireless temperature sensor in a large number of power conversion circuits during power conversion can be further reduced. Still further, the operating frequency of temperature measurement of the wireless temperature sensor according to the embodiment of the present disclosure may be lower than the operating frequency of broadcasting temperature data to the temperature data receiving device. In this way, a large amount of power consumption caused by frequent communication of unnecessary temperature data can be reduced, and at the same time, abnormal temperature data can be transmitted to the temperature data receiving equipment in time when the temperature is abnormal. By broadcasting temperature data, the wireless temperature sensor can transmit data wirelessly. By reducing the power consumption of the wireless temperature sensor, the volume of the wireless temperature sensor can be reduced and a long service life can be realized.

### BRIEF DESCRIPTION OF THE DRAWINGS

The above aspects and other aspects, features and advantages of specific embodiments of the present disclosure will become more apparent from the following description taken in conjunction with the accompanying drawings, in which:

FIG. 1 is a communication method for a wireless temperature sensor according to at least one embodiment of the present disclosure.

FIG. 2A is another communication method for a wireless temperature sensor according to at least one embodiment of the present disclosure.

FIG. 2B is another communication method for a wireless temperature sensor according to at least one embodiment of the present disclosure.

FIG. 3A is a schematic diagram of a broadcast frame of a wireless temperature sensor according to at least one embodiment of the present disclosure.

FIG. 3B is another schematic diagram of a broadcast frame of a wireless temperature sensor according to at least one embodiment of the present disclosure.

FIG. 3C is another schematic diagram of a broadcast frame of a wireless temperature sensor according to at least one embodiment of the present disclosure.

FIG. 4 is a schematic diagram of a wireless temperature sensor according to at least one embodiment of the present disclosure.

FIG. 5 is a schematic diagram of a wireless temperature sensor system according to at least one embodiment of the present disclosure.

FIG. 6 is a non-transitory computer-readable storage medium according to at least one embodiment of the present disclosure.

### DETAILED DESCRIPTION

Before proceeding to the following detailed description, it may be beneficial to set forth the definitions of certain words and phrases used throughout this patent application document. The terms “including” and “containing” and their derivatives refer to including but not limited to. The term “controller” or “control unit” refers to any device, system or part thereof that controls at least one operation. Such a controller may be implemented in hardware or a combination of hardware and software and/or firmware. The functions associated with any particular controller can be centralized or distributed, whether local or remote. The phrase “at least one”, when used with a list of items, means that different combinations of one or more of the listed items can be used, and only one item in the list may be needed. For example, “at least one of a, b and c” includes any one of the following combinations: a, b, c, a and b, a and c, b and c, a and b and c.

Definitions of other specific words and phrases are provided throughout this patent application document. It should be understood by those skilled in the art that in many cases, if not most cases, this definition also applies to the previous and future uses of words and phrases so defined.

The following description of various embodiments of the principles of the present disclosure in this patent application document with reference to the accompanying drawings is for illustration only and should not be interpreted as limiting the scope of the present disclosure in any way. Those skilled in the art will understand that the principles of the present disclosure can be implemented in any suitably arranged system or device. In some cases, the actions described in the specification can be performed in a different order and still achieve the desired results. Moreover, the processes depicted in the drawings do not necessarily require the specific order shown or sequential order to achieve the desired results. In certain embodiments, multitasking and parallel processing may be advantageous.

The existing temperature sensors are generally wired, that is, the existing temperature sensors transmit the obtained temperature data to the data receiving device by wired means (for example, through data lines). This wired mode is not conducive to the installation and maintenance of the temperature sensor, which limits the use scenarios of the temperature sensor.

In addition, in order to facilitate installation and use, a temperature sensor with small volume and long service life is desired. However, the volume of the temperature sensor is mainly affected by the volume of the power supply inside the temperature sensor. When a large-capacity and large-volume power supply is used in the temperature sensor to support the long-term use of the temperature sensor, the volume of the temperature sensor is large. When a small-capacity and small-volume power supply is used in the temperature sensor to facilitate the installation of the temperature sensor, the service time of the temperature sensor is short.

Therefore, a wireless temperature sensor with small volume and low power consumption is expected.

The disclosure provides a communication method for a wireless temperature sensor, the wireless temperature sensor includes: a temperature measuring module configured to collect temperature data; a communication module including an antenna component configured to broadcast temperature data to a temperature data receiving device; a control module configured to: control the temperature measuring module to collect temperature data at a first operating frequency, determine whether the temperature data is within a predetermined threshold range, and when the temperature data is within the predetermined threshold range, control the communication module to transmit the temperature data to the temperature data receiving device at a second operating frequency by broadcasting without establishing communication connection with the temperature data receiving device, wherein the first operating frequency is greater than the second operating frequency. The wireless temperature sensor and the communication method therefor according to the embodiment of the present disclosure can broadcast temperature data to a temperature data receiving device without establishing a communication connection. Because the process of establishing communication connection is reduced, the power consumption of wireless temperature sensor for communication can be significantly reduced. In addition, the controller of the wireless temperature sensor according to the embodiment of the present disclosure can realize the power management function, and can transmit power from the controller to the temperature measurement module via the control interface without a large number of power conversion circuits. By omitting a large number of power conversion circuits, the power consumption of the wireless temperature sensor in a large number of power conversion circuits during power conversion can be further reduced. Still further, the operating frequency of temperature measurement of the wireless temperature sensor according to the embodiment of the present disclosure may be lower than the operating frequency of broadcasting temperature data to the temperature data receiving device. In this way, a large amount of power consumption caused by frequent communication of unnecessary temperature data can be reduced, and at the same time, abnormal temperature data can be transmitted to the temperature data receiving equipment in time when the temperature is abnormal. By broadcasting temperature data, the wireless temperature sensor can transmit data wirelessly. By reducing the power consumption of the wireless temperature sensor, the volume of the wireless temperature sensor can be reduced and a long service life can be realized.

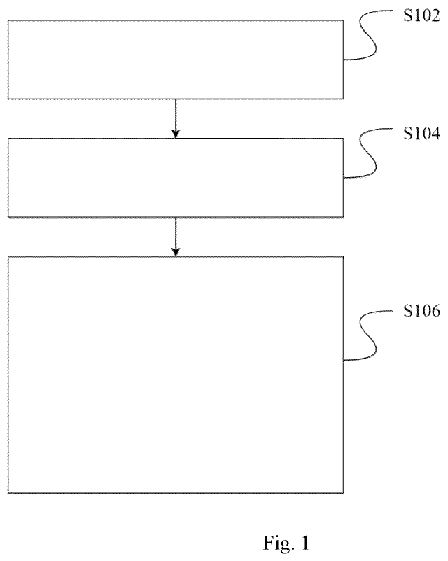

FIG. 1 is a communication method for a wireless temperature sensor according to at least one embodiment of the present disclosure.

As shown in FIG. 1, a communication method for a wireless temperature sensor may include steps S102, S104 and S106.

In step S102, the wireless temperature sensor may collect temperature data at a first operating frequency. The wireless temperature sensor may sense the temperature of the object to be measured and convert the temperature of the object to be measured into a usable output signal. For example, the wireless temperature sensor can collect temperature data at regular intervals, so as to collect temperature data at the first operating frequency. Wireless temperature sensors may include, but are not limited to, contact wireless temperature sensors (such as bimetallic thermometers, glass liquid thermometers, pressure thermometers, resistance thermometers, thermistors, thermocouples, etc.) and non-contact wireless temperature sensors (such as various non-contact wireless temperature sensors based on radiation thermometry including luminance method, radiation method and colorimetric method).

In step S104, the wireless temperature sensor may determine whether the temperature data is within a predetermined threshold range. The predetermined threshold range can be the normal temperature range of the object to be measured, or any predetermined temperature range, which is not specifically limited by the embodiment of the present disclosure. For example, the wireless temperature sensor may determine whether the temperature data is too high so as to exceed the upper limit of a predetermined threshold range. For example, the wireless temperature sensor may determine whether the temperature is too low so as to exceed the lower limit of a predetermined threshold range.

In step S106, when the temperature data is within a predetermined threshold range, the wireless temperature sensor may transmit the temperature data to the temperature data receiving device by broadcasting at a second operating frequency without establishing communication connection with the temperature data receiving device, wherein the first operating frequency is greater than the second operating frequency.

For example, the wireless temperature sensor may measure the temperature data of the object to be measured at a first operating frequency of temperature measurement once every minute, and the wireless temperature sensor may transmit the temperature data to the temperature data receiving device by broadcasting at a second operating frequency of communication once every ten minutes.

One-way communication scheme may be adopted between wireless temperature sensor and temperature data receiving equipment. That is to say, the wireless temperature sensor may transmit temperature data to the temperature data receiving device by broadcasting in one direction without establishing communication connection with the temperature data receiving device in advance. In the process of establishing communication connection, a lot of signaling will be transmitted, thus consuming a lot of energy. Power consumption can be saved by directly transmitting temperature data by broadcasting without establishing communication connection. The temperature data receiving device may be in sniffer mode, and the temperature data receiving device may receive all nearby broadcast frames and filter irrelevant broadcast frames through a specific frame header.

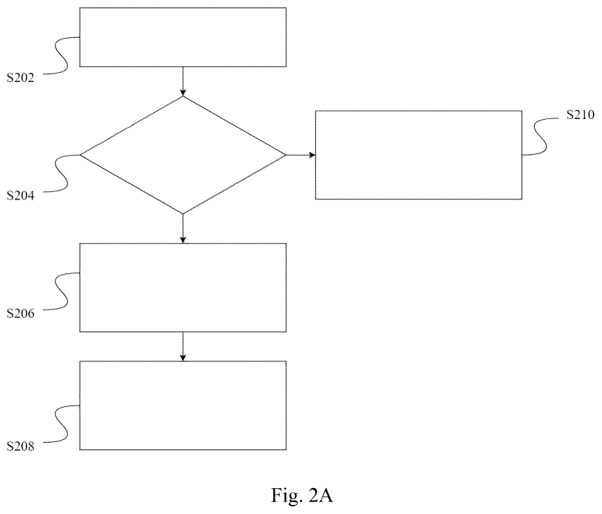

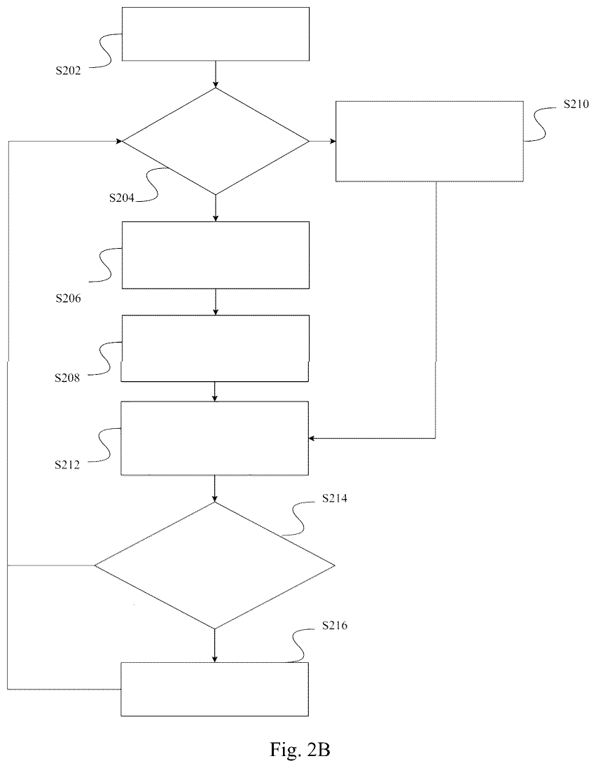

FIG. 2A is another communication method for a wireless temperature sensor according to at least one embodiment of the present disclosure.

As shown in FIG. 2A, the temperature collection and data communication logic for the wireless temperature sensor may include steps S202, S204, S206, S208 and S210.

In S202, the wireless temperature sensor may collect temperature data at a first operating frequency. For example, the wireless temperature sensor may measure the temperature every first predetermined time. The first predetermined time may correspond to the first operating frequency, for example, the first predetermined time may be determined based on the first operating frequency. For example, the first predetermined time may be one minute, and the wireless temperature sensor may measure the temperature every minute.

In S204, the wireless temperature sensor may determine whether the temperature data is within a predetermined threshold range. The description of the predetermined threshold range can refer to the content in step S104. For example, the temperature may be determined that whether it is too high so as to exceed the upper limit of a predetermined threshold range. For example, the temperature may be determined that whether it is too low so as to exceed the lower limit of a predetermined threshold range. The predetermined threshold range can be the normal temperature range of the object to be measured, or any predetermined temperature range, which is not specifically limited by the embodiment of the present disclosure.

When the temperature data is determined to exceed the predetermined threshold range, the flow may proceed to step S210. In step S210, the wireless temperature sensor may immediately broadcast the temperature data to the temperature data receiving device. For example, the wireless temperature sensor may immediately broadcast the maximum temperature value and the minimum temperature value in the current second predetermined time to the surroundings. The specific description of the second predetermined time can refer to the content in step S206 described below. The second predetermined time may be longer than the first predetermined time, for example, the second predetermined time may be ten minutes. For example, in response to the temperature exceeding the predetermined threshold range, the wireless temperature sensor may immediately broadcast the maximum temperature value and the minimum temperature value within the current ten minutes (for example, ten minute which is from the time point when the temperature exceeding the predetermined threshold range is detected to the previous time) to the temperature data receiving device.

When the temperature data is within a predetermined threshold range, the flow may proceed to S206. In S206, the wireless temperature sensor may update the maximum temperature value and the minimum temperature value at the second operating frequency. The second predetermined time may correspond to the second operating frequency, for example, the second predetermined time may be determined based on the second operating frequency. As described above, the first operating frequency may be greater than the second operating frequency, so the second predetermined time may be greater than the first predetermined time. For example, the wireless temperature sensor may update the maximum temperature value and the minimum temperature value within the second predetermined time interval every second predetermined time interval. For example, if the second predetermined time is ten minutes, the wireless temperature sensor may update the maximum temperature value and the minimum temperature value in the past ten minutes every ten minutes.

In S208, the wireless temperature sensor may transmit temperature data to the temperature data receiving device by broadcasting at the second operating frequency. For example, the wireless temperature sensor may transmit the maximum temperature value and the minimum temperature value by broadcasting within a second predetermined time to the temperature data receiving device. For example, the wireless temperature sensor may broadcast the maximum temperature value and the minimum temperature value in the past ten minutes to the temperature data receiving device.

FIG. 2B is another communication method for a wireless temperature sensor according to at least one embodiment of the present disclosure.

As shown in FIG. 2B, the temperature collection and data communication logic for the wireless temperature sensor may include steps S202, S204, S206, S208, S210, S212, S214 and S216. Steps S202, S204, S206, S208 and S210 in FIG. 2B are similar to the corresponding steps in FIG. 2A, and will not be repeated here.

As shown in FIG. 2B, in step S212, the wireless temperature sensor may determine the number of times of anomalies that the temperature data is not within the predetermined threshold range within a predetermined time period. The predetermined time period can be predefined or set by the user. For example, the user may set a predetermined time period according to the temperature monitoring requirements of the object monitored by the wireless temperature sensor. For example, the predetermined time period may be 1 h, 24 h, etc.

In step S214, the wireless temperature sensor may compare the number of times of anomalies with a threshold number of times to determine whether to update the second operating frequency. The threshold number of times may represent the expected number of times that the temperature of the object monitored by the wireless temperature sensor is abnormal in a predetermined time period. In one embodiment, the threshold number of times may be predefined or set by the user. In another embodiment, the threshold number of times may be obtained from historical data based on statistical principles. The threshold number of times may include an upper threshold number of times and a lower threshold number of times. When it is determined that the number of times of anomalies is higher than the upper threshold number or lower than the lower threshold number, the second operation frequency may be updated. When it is determined that the number of times of anomalies is between the upper threshold number and the lower threshold number, the second operation frequency may not be updated.

When it is determined not to update the second operation frequency, the flow may return to step S204.

When it is determined to update the second operation frequency, the flow may proceed to step S216. At step 216, the second operating frequency may be updated. For example, when it is determined that the number of times of anomalies is higher than the upper threshold number of times, the second operation frequency may be increased. For example, when it is determined that the number of times of anomalies is lower than the upper threshold number of times, the second operation frequency may be reduced. After updating the second operating frequency, the flow may return to step S204.

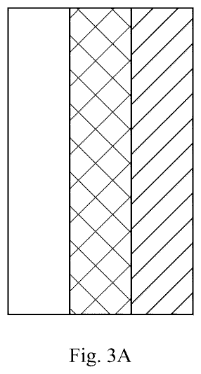

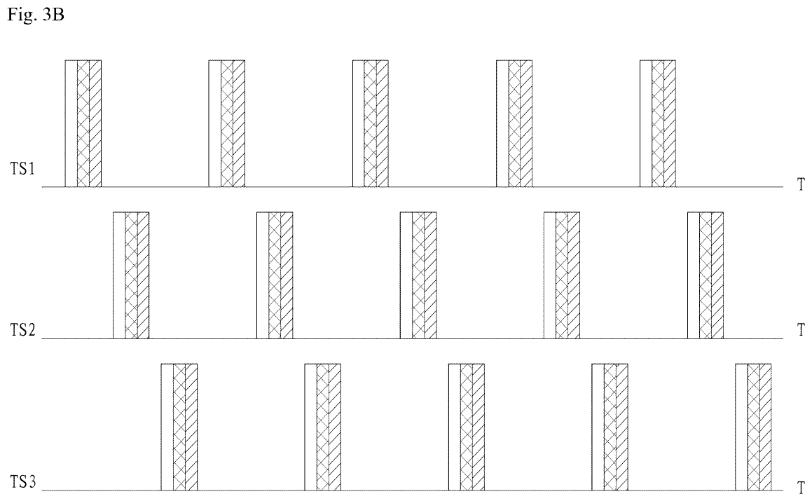

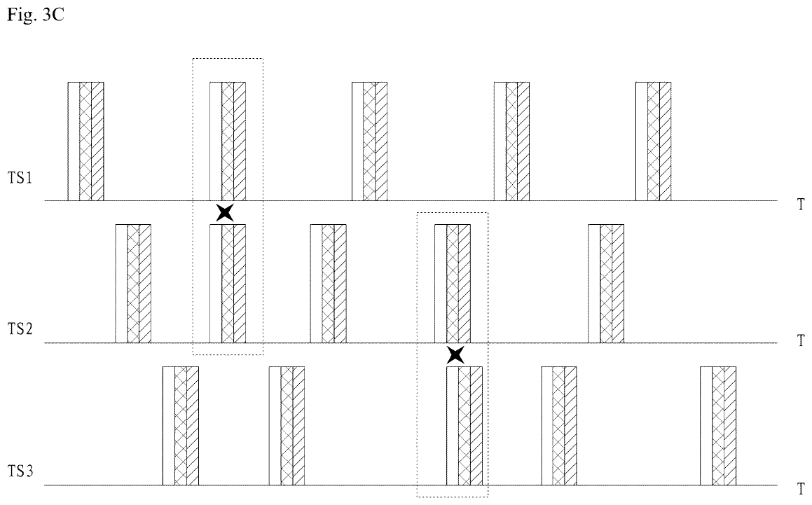

FIG. 3A is a schematic diagram of a broadcast frame of a wireless temperature sensor according to at least one embodiment of the present disclosure.

As shown in FIG. 3A, broadcast frames may be transmitted through one or more channels. Although it is shown in FIG. 3A that the broadcast frame is transmitted through three channels (for example, channel 1 represented by a box with no padding, channel 2 represented by a box with crossed lines, and channel 3 represented by a box with diagonal lines), those skilled in the art can understand that the broadcast frame can be transmitted through more or fewer channels. In this way, when the quality of one channel deteriorates, the temperature data receiving device may receive temperature data through other channels with good channel quality. Different channels may correspond to different channel frequencies. As an example, when the wireless temperature sensor communicates using the Bluetooth low-power BLE protocol, channel 1, channel 2 and channel 3 may correspond to NO. 37, 38 and 39 channels, respectively.

FIG. 3B is another schematic diagram of a broadcast frame of a wireless temperature sensor according to at least one embodiment of the present disclosure.

As shown in FIG. 3B, the wireless temperature sensor may repeatedly transmit the temperature data in multiple broadcast frames. For example, the broadcast frame of the wireless temperature sensor may be repeated five times (in FIG. 3B, T represents time), but this is only an example, and those skilled in the art can understand that the broadcast frame of the wireless temperature sensor may be repeated by a greater or less number.

The time interval between adjacent broadcast frames in a plurality of broadcast frames may be a predetermined time interval. For example, clocks of all wireless temperature sensors (for example, wireless temperature sensors TS1, TS2, TS3) may be synchronized, and different broadcast time intervals may be configured for each wireless temperature sensor. In this way, it is possible to avoid the collision between frames of different wireless temperature sensors (for example, wireless temperature sensor 1, wireless temperature sensor 2, wireless temperature sensor 3, etc. (more or less)) ensuring the high reliability of temperature data transmission. However, such an approach may require synchronization and configuration of each wireless temperature sensor. With the increase of the number of wireless temperature sensors (for example, tens, hundreds, etc.), the cost of synchronization and configuration may increase.

FIG. 3C is another schematic diagram of a broadcast frame of a wireless temperature sensor according to at least one embodiment of the present disclosure.

As shown in FIG. 3C, the wireless temperature sensor can repeatedly transmit temperature data in multiple broadcast frames. The time interval between adjacent broadcast frames in a plurality of broadcast frames may be a random time interval. For example, each of the wireless temperature sensors TS1, TS2 and TS3 in FIG. 3C may transmit a broadcast frame at random intervals. The random time may range from 10 ms to 40 ms, for example. When a broadcast frame is transmitted in this way, a frame collision may occur between different sensors (as shown by the dashed box in FIG. 3C). However, since each wireless temperature sensor repeatedly transmits broadcast frames through different channels for many times, and the interval between the broadcast frames repeatedly transmitted is random, the probability of all broadcast frames of the wireless temperature sensor colliding is very low. Therefore, each sensor can transmit the temperature data to the temperature data receiving device through broadcast frames without collision.

The advantage of this way is that the process of synchronizing the clock of the wireless temperature sensor and configuring the communication time of the wireless temperature sensor can be omitted. The greater the number of wireless temperature sensors, the more significant this advantage is.

The communication protocols used in FIGS. 1, 3A-3C may include, but are not limited to, one or more of Bluetooth Low Power BLE, Bluetooth BL, Sub-GHz, Wireless HART, Infrared Link, ZigBee, Radio Frequency Identification RFID, WIFI and Near Field Communication NFC. It should be understood by those skilled in the art that the above examples are only schematic, and the wireless temperature sensor according to the present disclosure can also use other existing or future developed communication protocols.

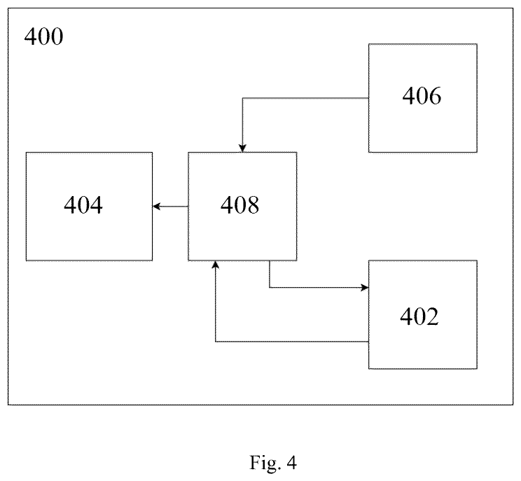

FIG. 4 is a schematic diagram of a wireless temperature sensor according to at least one embodiment of the present disclosure.

As shown in FIG. 4, the wireless temperature sensor 400 may include a temperature measuring module 402, a communication module 404, a power supply module 406 and a control module 408.

Although a storage device is not shown in FIG. 3, one of ordinary skill in the art will understand that the control module 408 may include one or more storage devices having instructions and/or data stored thereon. In addition, although FIG. 3 functionally shows various components including the temperature measuring module 402, the communication module 404, the power supply module 406, and the control module 408 as being in a single frame, those skilled in the art will understand that various components may actually include a plurality of components of the same type. Various components may or may not be stored in the same physical housing.

The wireless temperature sensor 400 may include, but is not limited to, contact wireless temperature sensors (such as bimetallic thermometers, glass liquid thermometers, pressure thermometers, resistance thermometers, thermistors, thermocouples, etc.) and non-contact wireless temperature sensors (such as various non-contact wireless temperature sensors based on radiation thermometry including luminance method, radiation method and colorimetric method). The wireless temperature sensor 400 can measure the temperature of the rotating equipment.

The temperature measuring module 402 is configured to collect the temperature data of the object to be measured. The temperature measuring module 402 may transmit the collected temperature data to the control module 408 in the form of analog signals or digital signals. Depending on the type of the wireless temperature sensor 400, the temperature measuring module 402 may have different configurations.

The communication module 404 may be configured to broadcast temperature data to a temperature data receiving device. For example, the control module 408 may control the communication module 404 to broadcast a broadcast frame including temperature data to the temperature data receiving device. The communication module 404 may include an antenna component. For example, the antenna component may include a 2.4G antenna.

The power supply module 406 may be configured to transmit power to the control module. The power supply module 406 may include a primary battery (for example, carbon battery, alkaline battery, lithium manganese battery, lithium secondary battery, zinc manganese battery, zinc silver battery, zinc air battery, lithium iron battery, etc.), a secondary battery (for example, lithium ion battery, nickel-hydrogen battery, nickel-cadmium battery, lead-acid battery, lithium polymer battery, etc.) and the like.

The control module 402 may be configured to control the temperature measurement module 402 to collect temperature data at a first operating frequency; determine whether the temperature data is within a predetermined threshold range; and when the temperature data is within a predetermined threshold range, control the communication module 404 to transmit the temperature data to the temperature data receiving device at a second operating frequency by broadcasting without establishing communication connection with the temperature data receiving device, wherein the first operating frequency is greater than the second operating frequency. The control module 402 may receive power from the power supply module 406.

Although not shown, the wireless temperature sensor 400 may also include one or more memories. The memory may include one or more computer program modules. One or more computer program modules are stored in a memory and can be configured to be read and executed by the control module 408. The one or more computer program modules include instructions for executing the above-mentioned various methods according to at least one embodiment of the present disclosure, which, when executed by the control module 408, can perform one or more steps of the above-mentioned various methods and their additional aspects according to at least one embodiment of the present disclosure.

The memory and control module 408 may be interconnected by a bus system and/or other forms of connection/communication mechanisms (not shown). For example, the bus may be a Peripheral Component Interconnection Standard (PCI) bus or an Extended Industry Standard Architecture (EISA) bus or the like. The communication bus can be divided into address bus, data bus and control bus.

For example, the control module 408 may be a central processing unit (CPU), a digital signal processor (DSP), a graphics processing unit (GPU) or other processing units with data processing capability and/or program execution capability, such as a field programmable gate array (FPGA). The control module 408 may be a general-purpose processor or a special-purpose processor, and may control other components in the wireless temperature sensor 400 to perform desired functions.

For example, the memory may include any combination of one or more computer program products, which may include various forms of computer-readable storage media, such as volatile memory and/or nonvolatile memory. The volatile memory may include, for example, random access memory (RAM) and/or cache, etc. Non-volatile memory may include, for example, read-only memory (ROM), hard disk, erasable programmable read-only memory (EPROM), portable compact disk read-only memory (CD-ROM), USB memory, flash memory, etc. One or more computer program modules may be stored on a computer-readable storage medium, and the control module 408 may run one or more computer program modules to realize various functions of the wireless temperature sensor 400. The computer-readable storage medium can also store various application programs and various data, as well as various data used and/or generated by the application programs, etc.

The control module 408 may obtain power from the power supply module 406 and perform battery management functions and power conversion functions. For example, the control module 408 can directly turn on and off the power of the temperature measuring module 402 without additionally setting the load switch of the temperature measuring module 402. For example, the control module may convert the power obtained from the power supply module 406 and provide the converted power to the temperature measurement module. Since the control module 408 is used to perform the battery management function and the power conversion function, a large number of power conversion circuits, such as but not limited to a linear regulator (LDO), a DC/DC converter, a buck boost converter and the like, can be omitted. By omitting a large number of power conversion circuits, the power consumption of the wireless temperature sensor 400 in a large number of power conversion circuits during power conversion can be reduced. The control module 408 may transmit power to the temperature measurement module 402 through the control interface. For example, the control interface includes a general-purpose input-output GIPO port. By using the control interface as the power transmission interface, the development cost can be reduced.

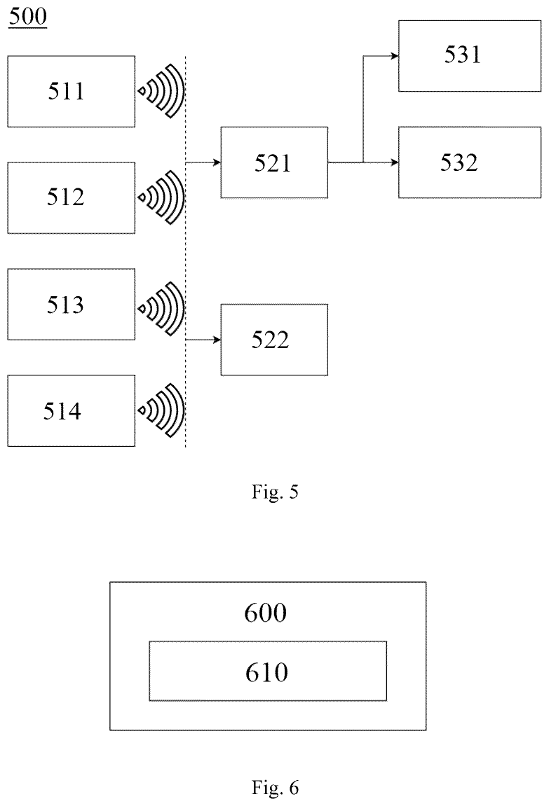

FIG. 5 is a schematic diagram of a wireless temperature sensor system according to at least one embodiment of the present disclosure.

As shown in FIG. 5, the sensor system 500 may include a group of wireless temperature sensors including a wireless temperature sensor 511, a wireless temperature sensor 512, a wireless temperature sensor 513, a wireless temperature sensor 514 (more or less), a gateway 521, a mobile device 522, a Supervisory Control And Data Acquisition/Distributed Control System (SCADA/DCS) 531, and a cloud 532.

The group of wireless temperature sensors may collect temperature data at a first operating frequency; determine whether the temperature data is within a predetermined threshold range; and when the temperature data is within a predetermined threshold range, transmit the temperature data to the temperature data receiving device by broadcasting at a second operating frequency without establishing communication connection with the temperature data receiving device, wherein the first operating frequency is greater than the second operating frequency.

The temperature data receiving device may include a gateway 521 or a mobile device 522. The gateway 521 may be in sniffing mode, so as to receive all broadcast frames nearby and filter irrelevant broadcast frames through specific frame headers. When the mobile device 522 is close to (for example, within 100 meters) one or more wireless temperature sensors in the group, the user can check the temperature data through the application in the mobile device 522.

The gateway 521 may package the temperature data from the group of wireless temperature sensors and transmit them to the cloud 532 (for example, through a remote communication protocol such as Ethernet) or the Supervisory Control And Data Acquisition/Distributed Control System 531 (for example, through a communication protocol such as Modbus).

The wireless temperature sensor and the communication method therefor according to the embodiment of the present disclosure can broadcast temperature data to a temperature data receiving device without establishing a communication connection. Because the process of establishing communication connection is reduced, the power consumption of wireless temperature sensor for communication can be significantly reduced. In addition, the controller of the wireless temperature sensor according to the embodiment of the present disclosure can realize the power management function, and can transmit power from the controller to the temperature measurement module via the control interface without a large number of power conversion circuits. By omitting a large number of power conversion circuits, the power consumption of the wireless temperature sensor in a large number of power conversion circuits during power conversion can be further reduced. Still further, the operating frequency of temperature measurement of the wireless temperature sensor according to the embodiment of the present disclosure may be lower than the operating frequency of broadcasting temperature data to the temperature data receiving device. In this way, a large amount of power consumption caused by frequent communication of unnecessary temperature data can be reduced, and at the same time, abnormal temperature data can be transmitted to the temperature data receiving equipment in time when the temperature is abnormal. By broadcasting temperature data, the wireless temperature sensor can transmit data wirelessly. By reducing the power consumption of the wireless temperature sensor, the volume of the wireless temperature sensor can be reduced and a long service life can be realized.

FIG. 6 is a non-transitory computer-readable storage medium according to at least one embodiment of the present disclosure.

As shown in FIG. 6, a non-transitory computer-readable storage medium 600 has stored thereon computer instructions 610 which, when executed by a processor, perform one or more steps of various methods and their additional aspects as described above.

For example, the non-transitory computer-readable storage medium 600 may be any combination of one or more computer-readable storage media, for example, one computer-readable storage medium contains program codes for executing the above various methods.

For example, when the program code is read by a computer, the computer can execute the program code stored in the computer storage medium, and perform one or more steps to realize, for example, the above-mentioned various methods and their additional aspects according to at least one embodiment of the present disclosure.

For example, the non-transitory computer-readable storage medium may include a memory card of a smart phone, a storage part of a tablet computer, a hard disk of a personal computer, a random access memory (RAM), a read-only memory (ROM), an erasable programmable read-only memory (EPROM), a portable compact disk read-only memory (CD-ROM), a flash memory, and other non-transitory readable storage media or any combination thereof.

The text and drawings are provided as examples only to help understand the present disclosure. They should not be construed as limiting the scope of the present disclosure in any way. Although certain embodiments and examples have been provided, based on the disclosure herein, it is clear to those skilled in the art that changes can be made to the illustrated embodiments and examples without departing from the scope of this disclosure.

Although the present disclosure has been described with exemplary embodiments, various changes and modifications can be suggested to those skilled in the art. This disclosure is intended to cover such changes and modifications as fall within the scope of the appended claims.

Any description in the present disclosure should not be understood as implying that any particular element, step or function is an essential element that must be included within the scope of the claims. The scope of the patent subject matter is limited only by the claims.

What is claimed is:

1. A communication method for a wireless temperature sensor, the method comprising:
collecting temperature data at a first operating frequency;
determining whether the temperature data is within a predetermined threshold range; and
when the temperature data is within the predetermined threshold range, transmitting the temperature data to a temperature data receiving device at a second operating frequency by broadcasting without establishing communication connection with the temperature data receiving device, wherein the first operating frequency is greater than the second operating frequency.

2. The method according to claim 1, wherein transmitting the temperature data to the temperature data receiving device by broadcasting comprises repeatedly transmitting the temperature data in a plurality of broadcast frames.

3. The method of claim 1, wherein each broadcast frame in the plurality of broadcast frames is transmitted through one or more channels.

4. The method according to claim 2, wherein a time interval between adjacent broadcast frames in the plurality of broadcast frames is a predetermined time interval.

5. The method according to claim 2, wherein a time interval between adjacent broadcast frames in the plurality of broadcast frames is a random time interval.

6. The method according to claim 1, wherein the transmitting by broadcasting is performed by one or more of Bluetooth low power BLE, Bluetooth BL, sub-Ghz, wireless HART, infrared link, ZigBee, radio frequency identification RFID, WIFI and near field communication NFC.

7. The method according to claim 1, wherein the wireless temperature sensor includes a control module, a power supply module and a temperature measuring module, wherein the control module obtains power from the power supply module and performs a power management function and a power conversion function, and wherein the control module transmits power to the temperature measuring module through a control interface.

8. The method of claim 7, wherein the control interface comprises a general-purpose input-output GIPO port.

9. The method of claim 1, further comprising when the temperature data is not within the predetermined threshold range, immediately transmitting the temperature data to the temperature data receiving device by broadcasting.

10. The method of claim 1, further comprising:
determining the number of times of anomalies that the temperature data is not within the predetermined threshold range within a predetermined time period;
comparing the number of times of anomalies with the threshold number of times; and
determining whether to update the second operating frequency based on a comparison result;
wherein the threshold number of times includes an upper threshold number of times and a lower threshold number of times.

11. The method of claim 10, wherein determining whether to update the second operating frequency based on the comparison result includes determining to update the second operating frequency based on the comparison result indicating that the number of times of anomalies is higher than the upper threshold number of times or lower than the lower threshold number of times.

12. The method of claim 11, wherein updating the second operating frequency includes:
increasing the second operating frequency based on the comparison result indicating that the number of times of anomalies is higher than the upper threshold number of times; and
reducing the second operating frequency based on the comparison result indicating that the number of times of anomalies is lower than the lower threshold number of times.

13. The method of claim 10, wherein determining whether to update the second operating frequency based on the comparison result includes determining not to update the second operating frequency based on the comparison result indicating that the number of times of anomalies is between the upper threshold number of times and the lower threshold number of times.

14. A wireless temperature sensor comprising:
a temperature measuring module configured to collect temperature data;
a communication module including an antenna component configured to broadcast temperature data to a temperature data receiving device;
a control module configured to:
control the temperature measuring module to collect temperature data at a first operating frequency,
determine whether the temperature data is within a predetermined threshold range, and
when the temperature data is within the predetermined threshold range, control the communication module to transmit the temperature data to the temperature data receiving device at a second operating frequency by broadcasting without establishing communication connection with the temperature data receiving device, wherein the first operating frequency is greater than the second operating frequency.
